(19) United States
(12) Patent Application Publication
(10) Pub. No.: US 2003/0116650 A1
(43) Pub. Date: Jun. 26, 2003

(54) Fuel-injection valve comprising a swirl element

(76) Inventors: Guenter Dantes, Eberdingen (DE); Detlef Nowak, Untergruppenbach (DE); Joerg Heyse, Besigheim (DE); Michael Klaski, Grossbottwar (DE); Wolfgang Mertzky, Schwieberdingen (DE); Matthias Waldau, Pforzheim (DE)

Correspondence Address: KENYON & KENYON, ONE BROADWAY, NEW YORK, NY, 10004, US

(21) Appl. No.: 10/148,774

(22) PCT Filed: Sep. 27, 2001
(86) PCT No.: PCT/DE01/03711

(30) Foreign Application Priority Data
Oct. 4, 2000 (DE) 100 48 935.4

(51) Int. Cl. B05B 1/34

(52) U.S. Cl. 239/463; 239/468; 239/475; 239/483

(57) ABSTRACT

The present invention relates to a fuel injector for fuel injection systems of internal combustion engines, including, among others, an actuator (10, 11, 12) and a movable valve part (5, 7) cooperating with a fixed valve-seat (22) formed at a valve-seat member (16), to open and close the valve. Arranged downstream from the valve seat (22) is a disk-shaped swirl element (25) which is provided with at least one inlet region (27) and also at least one outlet opening (29), and which includes at least one swirl channel (28) upstream from the outlet opening (29). The inlet region (27) in the swirl element (25) receives a central inflow. All swirl channels (28) originate from here, so that the fuel, which flows through the swirl channels (28) exclusively from the inside towards the outside in the radial direction, is imparted with a swirl component.

The fuel injector is particularly suitable as a high-pressure injector for direct fuel injection into a combustion chamber of a mixture-compressing internal combustion engine using external ignition.

### BACKGROUND INFORMATION

The present invention is based on a fuel injector according to the species defined in claim 1.

It is already widely known to provide fuel injectors with swirl-generating elements, which impart a swirl component to the fuel to be sprayed off, so that the fuel is better atomized and disintegrates into smaller droplets. In this context, it is already known, on the one hand, to locate the swirl-generating means upstream, i.e. before the valve seat, and, on the other hand, downstream, i.e. behind the valve seat.

Swirl-generating means located downstream from the valve seat are usually designed to supply fuel to the radially outward-lying ends of swirl channels, the fuel then being fed radially inward to a swirl chamber, which it enters with a tangential component. The swirl-imparted fuel then emerges from the swirl chamber. From the laid-open document DE-OS 198 15 775, a fuel injector is already known in which a swirl plate having such a flow is provided downstream from the valve seat.

Examples of fuel injectors having swirl elements disposed upstream from the valve seat are shown, for instance, in WO 98/35159 or DE-OS 197 36 682. In these valves, too, the swirl elements are basically designed such that the fuel is fed radially from the outside in the direction of the central valve seat.

Furthermore, from DE-OS 195 27 626 a fuel injector is already known where a nozzle plate is provided downstream from the valve seat. This nozzle plate has a plurality of swirl grooves, which are arranged like a rotor and distributed across the nozzle plate in a circular manner. Each individual swirl groove has an inlet area from which the fuel, having a partially radial component, is carried in the direction of a ring gap having a larger diameter.

So-called multilayer electroplating for producing orifice plates that are particularly suitable for use in fuel injectors has already been described in detail in DE OS 196 07 288. This manufacturing principle for producing disks using multiple electroplating metal deposition of different patterns on one another, so that a one-piece disk results, expressly is to be part of the disclosure of the present invention. Micro-electroplating metal deposition in several surfaces or layers may also be used to produce the swirl plates.

### SUMMARY OF THE INVENTION

The fuel injector according to the present invention having the characterizing features of claim 1 has the advantage of obtaining a very high atomization quality of a fuel to be spray-discharged. As a result, such an injector of an internal combustion engine makes it possible, among other things, to reduce the exhaust-gas emission of the internal combustion engine and also to reduce the fuel consumption.

The swirl element is advantageously securable to the fuel injector in a very uncomplicated and reliable manner. Due to the central incident flow of the swirl element, the required mounting areas are located at a considerable distance from the valve seat, the adjoining outlet opening and the inlet area of the swirl element. Such an arrangement allows a reduction of the dead volume in the incident flow behind the valve seat. The danger of so-called late sprays during engine operation is considerably reduced in this manner, since only a small quantity of fuel, or no fuel at all, is stored in the inflow-area.

The spray-off geometry, which lies radially further outside due to the central incident flow of the swirl channels, may be advantageous in particular when using the fuel injector for the direct injection into the combustion chamber of an internal combustion engine having externally supplied ignition, since the danger of coking of the spray-off geometry is reduced in this way.

Advantageous further refinements and improvements of the fuel injector mentioned in claim 1 are-rendered possible by the measures specified in the dependent claims.

A transverse spray-off of fuel at an angle γ with respect to the longitudinal valve axis, as could be required under certain installation conditions, may be accomplished very easily by using the fuel injector of the present invention. Transversely running outlet openings already may be integrated in the swirl element in an uncomplicated manner without a spray-off component having to be transversely installed at the injector.

The swirl element may be manufactured inexpensively in an especially advantageous manner. A particular advantage is that the swirl disks may be produced simultaneously and extremely precisely in large quantities in a reproducible manner (high batch capability). It is particularly advantageous here to produce the swirl disk by using so-called multilayer electroplating. Due to their metal design, such swirl elements are very safe from breakage and are easy to install. Using multilayer electroplating grants an extremely high design freedom since the contours of the opening regions (inlet regions, swirl channels, outlet openings) in the swirl disk may be freely selected.

It is particularly advantageous to construct the swirl disk to include three layers by performing two or three electroplating steps for the metal deposition. In this context, the upstream layer constitutes a cover layer, which has a central inlet opening that completely covers the swirl channels of an intermediate swirl-generating layer. The swirl-generating layer is formed by a plurality of material regions, which specify the contours of the swirl channels due to their contouring and their geometric position with respect to one another. As a result of the electroplating process, the individual layers are built up on top of one another without separation points or joining points in such a way that they represent a continuous, homogenous material. In this respect, the “layers” are to be understood as a mental aid.

### BRIEF DESCRIPTION OF THE DRAWING

Exemplary embodiments of the invention are shown simplified in the drawing and elucidated in greater detail in the following description.

The Figures show:

FIG. 1: a partially depicted fuel injector in cross-section;

FIG. 2: a plan view of a swirl element shown in FIG. 1 along a line I-I;

FIG. 3: a second exemplary embodiment of a fuel injector including a swirl element having a transversely running outlet opening;

FIG. 4: a further exemplary embodiment of a swirl element having three swirl channels, in a plan view;

FIG. 5: a longitudinal section through a swirl element produced by multi-layer electroplating;

FIG. 6: a view of an intermediate swirl-generating layer of the swirl element shown in FIG. 5, in cross section;

FIG. 7: a second cross-sectional view of a central swirl-generating layer of a swirl element produced by multi-layer electroplating;

FIG. 8: a third cross-sectional view of an intermediate swirl-generating layer of a swirl element produced by multi-layer electroplating; and

FIG. 9: another exemplary embodiment of a partially shown fuel injector having a swirl element.

### DESCRIPTION OF THE EXEMPLARY EMBODIMENTS

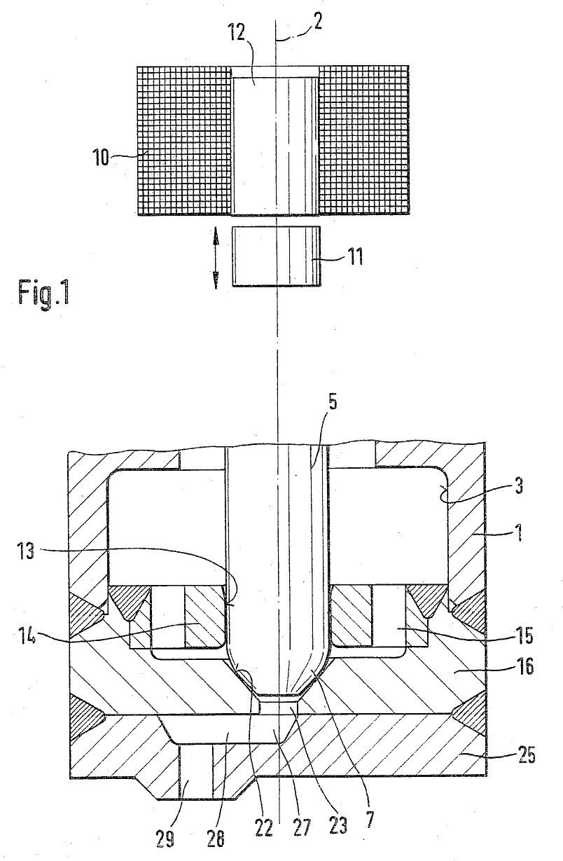

FIG. 1 partially shows in simplified form a valve in the form of an injection valve for fuel injection systems of mixture-compressing, externally ignited internal combustion engines as a first exemplary embodiment. The injection valve has a tubular valve-seat support 1, in which a longitudinal opening 3 is formed concentrically to a longitudinal valve axis 2. Disposed in longitudinal opening 3 is a valve needle 5, which has a valve-closure segment 7 at its downstream end.

The fuel injector is actuated in a known manner, e.g. electromagnetically. For axial movement of valve needle 5, and thus for opening a (not shown) restoring spring against the spring tension, or for closing the fuel injector, a schematically sketched electromagnetic circuit including a magnetic coil 10, an armature 11 and a core 12 is used. Armature 11 is connected to the end of valve needle 5 facing away from valve-closure segment 7 by a welding seam that is formed, for instance, by laser, and which points to core 12.

Instead of the electromagnetic circuit, another energizable actuator, e.g. a piezo stack, may also be used in a comparable fuel injector, or the axially movable valve part may be actuated by hydraulic pressure or servo pressure.

During the axial movement, valve needle 5 is guided by a guide opening 13 of a guide element 14. Guide element 14 is provided with at least one flow opening 15 through which fuel may flow from longitudinal opening 3 in the direction of a valve seat. Guide element 14, which may be in the shape of a disk, for instance, is fixedly connected to a valve-seat member 16 by a circumferentially extending welding seam, for example. Valve-seat member 16 is sealingly mounted, by welding, for instance, on the end of valve-seat support 1 facing away from core 12.

The position of valve-seat member 16 determines the magnitude of the lift of valve needle 5 since the one end position of valve needle 5 in the case of a non-energized magnetic coil 10 is determined by the seating of valve-closure segment 7 at valve-seat surface 22 of valve-seat member 16, which tapers conically in a downstream direction. Given an energized magnetic coil 10, the other end position of valve needle 5 is determined, e.g. by the-seating of armature 11 on core 12. Therefore, the path between these two end positions of valve needle 5 constitutes the lift. Valve-closure segment 7 cooperates with truncated-cone-shaped valve-seat surface 22 of valve-seat member 16 to form a sealing seat. Downstream from valve-seat surface 22, valve-seat member 16 has a central outlet opening 23.

Downstream from outlet opening 23, a swirl element 25, in the shape of a disk, for instance, is disposed at valve-seat member 16, which is mounted on valve-seat member 16 again by welding, for example. Swirl element 25 is provided with a single central inlet region 27, which immediately adjoins outlet opening 23 of valve-seat member 16 and lies in the region of longitudinal valve axis 2. Beginning at this inlet region 27, at least one swirl channel 28 extends radially towards the outside, and discharges there into an outlet opening 29 of swirl element 25.

In particular, the fuel injector is designed as a so-called multi-hole valve (FIG. 4) that is particularly suited for injecting fuel directly into a combustion chamber (not shown).

Fuel injectors for directly injecting fuel into a combustion chamber whose outlet openings are directly exposed to the combustiqn-chamber atmosphere are extremely susceptible to coking. The fuel injector of the present invention is to largely prevent coke deposits of the combustion chamber in the region of outlet openings 29 from obstructing the outlet openings and in this manner significantly changing the injection quantities over the valve's lifetime.

Swirl component 25 is a disk-shaped component that is designed as an apertured spray disk and has two layers, at least in the region of the opening structure 27, 28, 29. The upper layer facing valve-seat member 16 includes the central inlet region 27 and the at least one swirl channel 28, while the lower layer of the opening structure is formed by outlet opening 29. Swirl element 25 is produced from sheet metal, for instance, the opening contours being introduced by stamping, eroding and/or laser drilling.

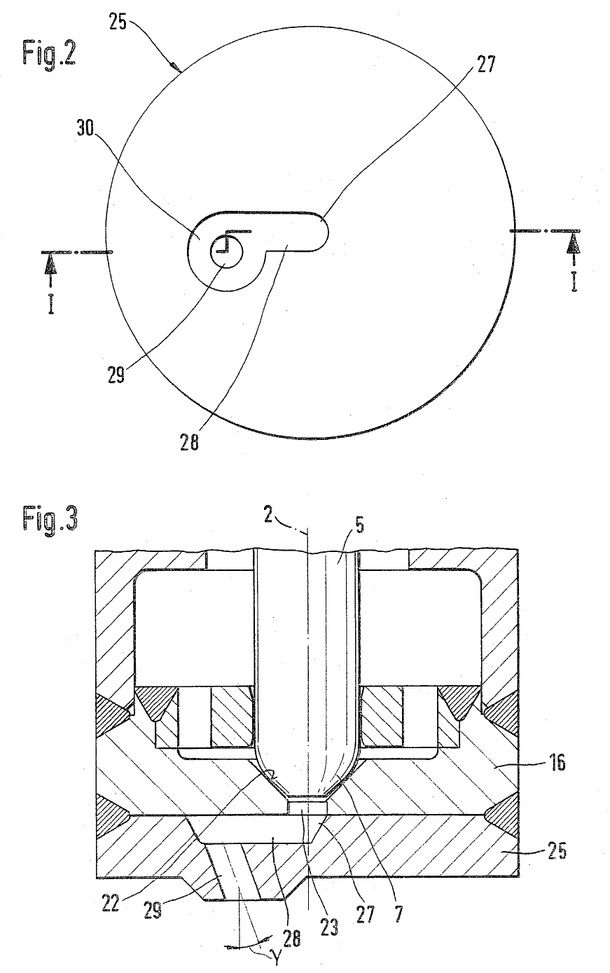

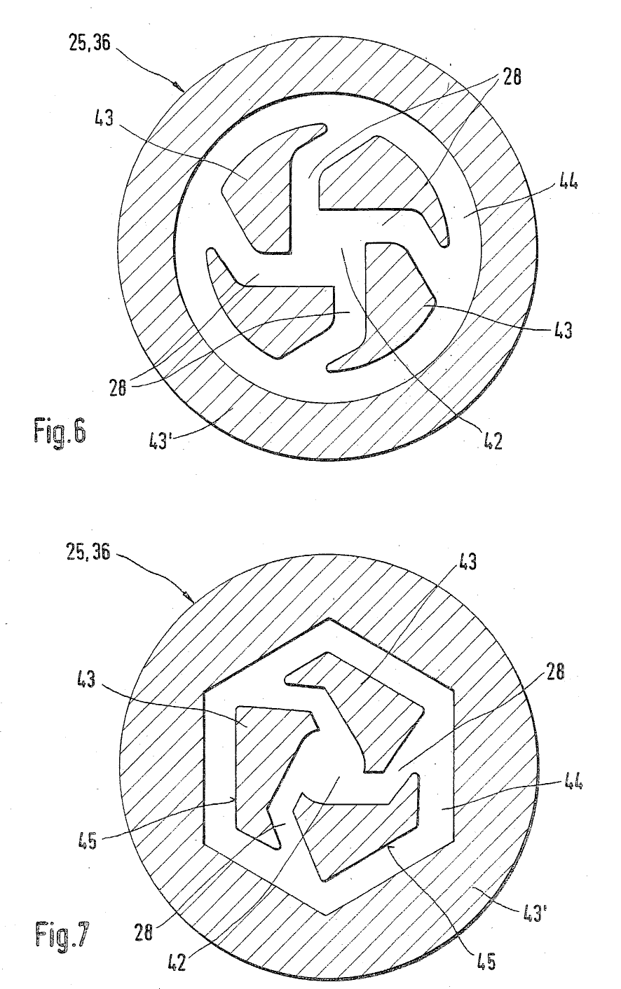

FIG. 2 shows a plan view of swirl element 25 shown in FIG. 1 along line I-I. It becomes clear here that swirl channel 28 extends radially outward from central inlet region 27, to tangentially discharge into a swirl chamber 30 disposed in an off-set manner with respect to longitudinal valve axis 2. The opening contour of the upper layer of swirl element 25, therefore, largely corresponds to the shape of a FIG. 6 or the shape of a FIG. 9. The edges of inlet region 27, of swirl channel 28 and swirl chamber 30 are slanted, for instance, resulting in swirl channel 28 that may have a notched groove-shaped or v-shaped geometry, that is, one that has the shape of an inversed roof-ridge. Since swirl channel 28 tangentially discharges into swirl chamber 30 and outlet opening 29 is centrally disposed with respect to swirl chamber 30 by which it is concentrically surrounded, outlet opening 29, which extends parallel to longitudinal valve axis 2, is at an offset from swirl channel 28. In this manner, a swirl component is imparted to the fuel flowing through swirl chamber 30.

Depending on the requested jet structure and/or the jet homogeneity or the installation conditions at the cylinder head of an internal combustion engine as well as its combustion chamber atmosphere, it may be useful to vary the number of outlet openings 29, their arrangement with respect to one another, and their angle with respect to longitudinal valve axis 2. FIGS. 3 and 4 show two additional exemplary embodiments of swirl elements 25 according to the present invention.

FIG. 3, using the same view as that in FIG. 1, shows a second exemplary embodiment of a fuel injector having a swirl element 25 provided with a transversely extending outlet opening 29, SO that identical reference numerals have been used for corresponding components. In this example, outlet opening 29 has an angle γ with respect to longitudinal valve axis 2, outlet opening 29 extending in an inclined manner in such a way that it faces longitudinal valve axis 2 in the spray-off direction. However, the incline direction may also be the reversed; even an inclined design of outlet opening 29 is possible.

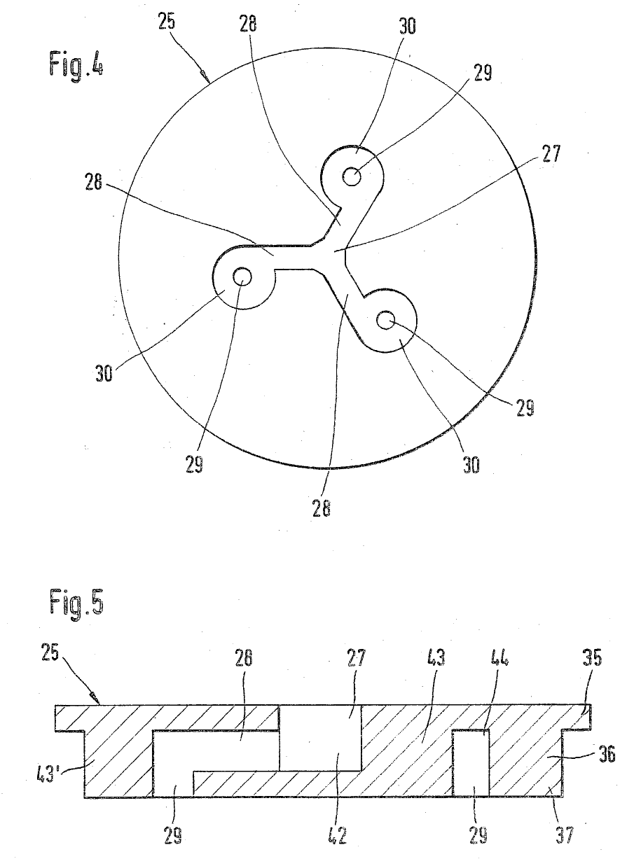

FIG. 4 shows a further exemplary embodiment of a swirl element 25 having three swirl channels 28, in a plan view. Here, three swirl channels 28 originate at central inlet region 27, extending radially outward, for instance, at a 120° offset with respect to each other. At their ends, each swirl channel 28 discharges into an individual swirl chamber 30, from which, in turn, the swirl-imparted fuel may enter into an outlet opening 29 and may be sprayed off from there. Swirl channels 28 may also be unevenly distributed over the circumference. For a desired filling of the combustion chamber with fuel, outlet openings 29 may be aligned, for example, at different angles to longitudinal valve axis 2, all outlet openings 29, for example, moving away from longitudinal valve axis 2 in the downstream direction at an angle, or facing it. FIGS. 5 through 9 show exemplary embodiments of swirl elements 25, which have an incident flow and through-flow and operate according to the same principle as in the examples according to FIGS. 1 through 4, but are produced by so-called multi-layer electroplating.

FIG. 5 shows a longitudinal section through a first swirl element 25 produced by multi-layer electroplating. Disk-shaped swirl element 25 is formed, for instance, from three planes, or layers, that are deposited by electroplating on top of one another and consequently axially follow one another in the installed state. The three layers of swirl element 25 are hereinafter denoted according to their function by inlet layer 35, swirl-generating layer 36 and bottom layer 37. Upper inlet layer 35 has a larger outer diameter than swirl-generating layer 36 and bottom layer 37. Such an outer contour is useful for an uncomplicated and secure installation of swirl element 25 into a receiving opening 39 of a holding part 40 (FIG. 9).

The fuel flows centrally over a central inlet region 27, designed as a circular inlet opening, in upper inlet layer 35, which in all other respects is a pure material layer, into swirl element 25. Downstream from there, it reaches a central region 42 of intermediate swirl-generating layer 36. From central region 42, the fuel may enter freely four swirl channels 28, for instance, in intermediate swirl-generating layer 36. Due to the galvanic metal deposition, swirl-generating layer 36 is structured such that material regions 43 and opening regions (central region 42, swirl channels 28) alternate with each other in a particular desired structure. For better understanding, FIG. 6 shows in cross-section a view of intermediate swirl-generating layer 36 of swirl element 25, which was shown in FIG. 5 as a sectional view.

Inner material regions 43 are bent in a wing-like manner or are designed in the shape of an arc or parabola, consequently resulting in swirl channels 28 forming as interspaces between material regions 43 that have a similarly bent form. The flow passes through swirl channels 28 from central region 42 towards the outside where the emerging fuel, to which a swirl has been imparted due to the channel design, enters a circular flow region 44, partially bounces against the inner wall of an outer material region 43′, and is set in rotation. Circular flow region 44 is thus surrounded on the outside by also circular material region 43′. In the exemplary embodiment depicted in FIG. 5, a ring gap in lower bottom layer 37 adjoins the circular flow region 44 of intermediate swirl-generating layer 36 as outlet opening 29. Thus, outlet opening 29 is offset toward the outside with respect to central inlet region 27 of swirl element 25.

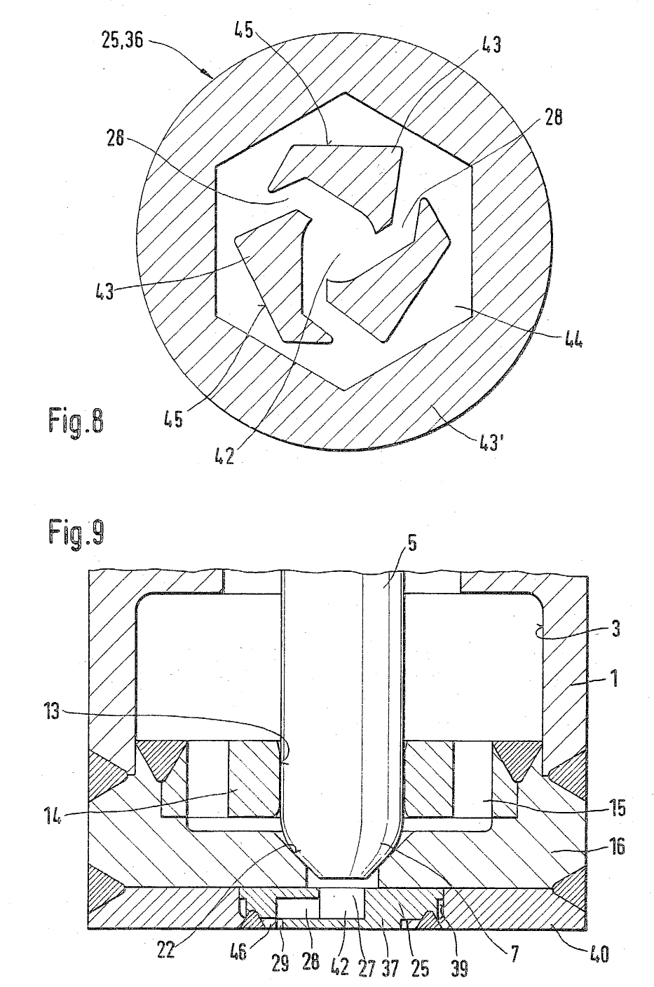

FIGS. 7 and 8 show two additional cross-sectional views of an intermediate swirl-generating layer 36 of a swirl element 25 produced by multi-layer metalplating. Three inner material regions 43 are provided in the intermediate swirl-generating layer 36 of these two swirl elements 25, which, in turn, are deposited such that swirl channels 28 formed between them run in the shape of a hook, and that a swirl is imparted to the fuel flowing through them. The outer circular material region 43′ has a hexagonal shape, for instance, on its inner side, so that circular flow region 44 is bounded by this hexagonal wall.

In the example shown in FIG. 7, inner material regions 43 extend with their outward-pointing boundary surfaces 45 parallel to the wall sections of the hexagonal inner side of outer material region 43. In contrast, according to FIG. 8, the material regions 43 of swirl-generating layer 36 of swirl element 25 are designed such that approximately the center of each individual outward-pointing boundary surface 45 of material regions 43 lies across from a corner of the hexagonal inner side of outer material region 43′. These structures of swirl-generating layer 36 may be varied as desired.

FIG. 9 shows another exemplary embodiment of a partially depicted fuel injector having a swirl element 25. This swirl element 25 has one important difference compared to all other previously described exemplary embodiments. Bottom layer 37 of swirl element 25 has a smaller outer diameter than the outer diameter of superposed swirl-generating layer 36 and has no outlet opening 29. Instead, an inward projecting collar 46 is provided at holding part 40 at the level of bottom layer 37 of swirl element 25. This collar 46 extends under swirl element 25 at swirl-generating layer 36 and reaches in a dimensionally accurate manner close to bottom layer 37. A small gap between bottom layer 37 and collar 46 remains, which forms outlet opening 29 as ring gap. The mounting options of holding part 40 shown in FIG. 9 and also of swirl element 25 in holding part 40 by (laser) welded seams are analogously applicable to the mounting of swirl elements 25 of FIGS. 5 through 8 as well.

The width of outlet opening 29 formed as a ring gap may be adjusted in such a way that, relative to the cross-section of swirl channels 28, outlet opening 29 constitutes the throttling cross-section. The flow back-up occurring in flow region 44 and outlet opening 29 causes a homogenization of the velocity field across the periphery of outlet opening 29. In this respect, local fuel accumulations and streaks may be avoided. However, in those cases where just such streaks are desired for particular spray patterns, the width of ring-gap outlet opening 29 may be enlarged in relation to the swirl-channel widths, so that fuel accumulations are produced in the regions of swirl channels 28 discharging into flow region 44. In place of the ring gap as outlet opening 29 it is also possible to provide outlet openings 29 that have a fundamentally different design.

Swirl elements 25 according to FIGS. 5 through 9 are formed of several metal layers, by instance by galvanic deposition (multi-layer electroplating). Due to the deep-lithographic production using electroplating technology, particular features are found in the shaping, of which several are briefly indicated here:

layers having a thickness that does not vary over the disk surface;

substantially vertical cuts in the layers that form the cavities flowed through in each case as a result of the deep lithographic structuring (deviations of about 30 with respect to optimally vertical walls may occur due to production engineering;

desired undercuttings and overlappings of the cuts as a result of multi-layer design of individually patterned metal layers;

cuts having any cross-sectional forms with largely paraxial walls;

one-piece design of the swirl disk, since the individual metal depositions occur in immediate succession.

In the following sections, the method for producing swirl disks 25 is only explained briefly. All method steps of the electroplating metal deposition for producing an orifice plate have already been described in detail in DE OS 196 07 288. It is characteristic for the method for the successive use of photolithographic steps (UV depth lithography) and subsequent micro-electroplating that it also ensures a high precision of the patterns even on a large scale, so that it is ideally suited for use in mass production with large piece numbers (high batch capacity). A plurality of swirl disks 25 may be simultaneously produced on a panel or wafer.

The starting point for the method is a flat and stable supporting plate that may be made of metal (titanium, steel), silicon, glass, or ceramic, for example. At least one auxiliary layer is optionally first deposited on the supporting plate. In this context, the auxiliary layer is, for example, an electroplated starting layer (e.g. TiCuTi, CrCuCr, Ni) that is needed for the electrical conducting for the later micro-electroplating. The auxiliary layer is deposited, for example, by sputtering or by currentless metal deposition. After this pretreatment of the supporting plate, a photoresist is applied to the entire surface of the auxiliary layer, e.g. by rolling or spin-coating.

The thickness of the photoresist should correspond to the thickness of the metal layer that is to be realized in the subsequent electroplating process, i.e., the thickness of lower bottom layer 37 of swirl element 25. The photoresist layer may be composed of one or a plurality of layers of a photo-patternable foil or of a fluid resist (polyimide, photoresist). If an optional sacrificial layer is to be electroplated into the later produced resist patterns, the thickness of the photoresist is to be increased by the thickness of the sacrificial layer. The metal pattern to be produced is to be inversely transferred to the photoresist with the help of a photolithographic mask. One possibility is to expose the photoresist directly through the mask using UV exposure (printed-circuit board exposing means or semiconductor exposing means) (UV depth lithography) and to subsequently develop it.

The negative pattern ultimately produced in the photoresist for subsequent layer 37 of swirl disk 25 is filled with metal (e.g. Ni, NiCo, NiFe, NiW, Cu) by electroplating (metal deposition). Due to the electroplating, the metal lies close to the contour of the negative pattern, so that the defined contours are reproduced in it true to form. To produce the structure of swirl element 25, the steps starting from the optional deposition of the auxiliary layer must be repeated according to the number of desired layers, so that for a three-layer swirl element 25, two (lateral overgrowth) or three electroplating steps are performed. Different metals may also be used for the layers of a swirl element 25 yet are only able to be used in each case in a new electroplating step.

After top cover layer 35 has been deposited, the remaining photoresist is removed from the metal patterns by wet-chemical stripping. In the case of smooth, passivated supporting plates (substrates), swirl elements 25 are able to be detached and separated from the substrate. In the case of supporting plates having good adhesion of swirl elements 25, the sacrificial layer is selectively etched away from the substrate and swirl element 25, thereby making it possible to lift and separate swirl disks 25 from the supporting plate.

What is claimed is:

1. A fuel injector for fuel injection systems of internal combustion engines, in particular for the direct injection of fuel into a combustion chamber of an internal combustion engine, having a longitudinal valve axis (2), an actuator (10, 11, 12), a movable valve part (5, 7) cooperating with a fixed valve seat (22), formed on a valve-seat member (16), to open and close the valve, and having a swirl element (25), disposed downstream from the valve seat (22), which is provided with at least one inlet region (27) as well as at least one outlet opening (29), and which includes at least one swirl channel (28) upstream from the outlet opening (29),
wherein a single inlet region (27) is centrally provided in the swirl element (25) from which all swirl channels (28) originate, through which the fuel is able to flow exclusively from the inside to the outside in the radial direction.

2. The fuel injector as recited in claim 1, wherein an outlet opening (23) is centrally provided downstream from the valve-seat (22) in the valve-seat member (16), which points directly to the inlet region (27) of the swirl element (25).

3. The fuel injector as recited in claim 1 or 2, wherein the swirl element (25) is disk-shaped.

4. The fuel injector as recited in one of the claims 1 through 3 ,
wherein the swirl element (25) is directly mounted on the valve-seat member (16).

5. The fuel injector as recited in one of the claims 1 through 4,
wherein the at least one outlet opening (29) of the swirl element (25) is disposed at a radial offset toward the outside with respect to the inlet region (27).

6. The fuel injector as recited in one of the preceding claims,
wherein a plurality of swirl channels (28) originates from the inlet region (27), to which precisely one outlet opening (29) is assigned in each case.

7. The fuel injector as recited in one of claims 1 through 5, wherein a plurality of swirl channels (28) originates from the inlet region (27), which discharge into a single outlet opening (29).

8. The fuel injector as recited in claim 7, wherein the outlet opening (29) is implemented as a ring gap.

9. The fuel injector as recited in one of the preceding claims,
wherein the at least one swirl channel (28) has a notched channel-shaped or v-shaped geometry.

10. The fuel injector as recited in claim 6,
wherein each swirl channel (28) discharges tangentially into a swirl chamber (30) which concentrically surrounds the outlet opening (29).

11. The fuel injector as recited in claim 10,
wherein the swirl channel (28) and the swirl chamber (30) lying in the same plane as swirl element (25) together are configured in the shape of a FIG. 6 or the shape of a FIG. 9.

12. The fuel injector as recited in one of the claims 1 through 8,
wherein the swirl element (25) may be produced by multi-layer galvanic metal-deposition [electro-deposition].

13. The fuel injector as recited in claim 12,
wherein the swirl element (25) includes two or three layers and the layers are built up directly on top of one another in an adhesive manner.

14. The fuel injector as recited in claim 12 or 13, wherein a single central inlet region (27) is provided in an upper inlet layer (35), a central region (42) follows in a swirl-generating layer (36) adjoining downstream, swirl channels (28) running from the central region (42) radially towards the outside, and at least one outlet opening (29) lying further outside relative to the inlet region (27) is introduced in a lower bottom layer (37).

15. The fuel injector as recited in claim 14, wherein the swirl-generating layer (36) includes a plurality of inner material regions (43) that are bent in a wing-like manner or have a curved or parabolic form, so that swirl channels (28) having a similarly bent form result as interspaces between the material regions (43).

16. The fuel injector as recited in one of the claims 1 through 3,
wherein the swirl element (25) is inserted in a holding part (40), which is secured to the valve-seat member (16).

17. The fuel injector as recited in claim 16,
wherein the holding part (40) is provided with a collar (46) projecting toward the swirl element (25), so that an interspace is formed between the swirl element (25) and the collar (46), which constitutes the outlet opening (29).
